(19) United States
(12) Patent Application Publication
(10) Pub. No.: US 2024/0402418 A1
(43) Pub. Date: Dec. 5, 2024

(54) HOLLOW-CORE OPTICAL FIBER WITH SINGLE NESTED CAPILLARIES EXHIBITING IMPROVED CONFINEMENT LOSS

(71) Applicant: CORNING INCORPORATED, CORNING, NY (US)

(72) Inventors: Paulo Clovis Dainese, JR., Painted Post, NY (US); Ming-Jun Li, Horseheads, NY (US); Dan Trung Nguyen, Painted Post, NY (US); Ilia Andreyevich Nikulin, Wilmington, NC (US)

(21) Appl. No.: 18/663,838

(22) Filed: May 14, 2024

Related U.S. Application Data
(60) Provisional application No. 63/469,677, filed on May 30, 2023.

(51) Int. Cl. G02B 6/032

(52) U.S. Cl. CPC G02B 6/032

(57) ABSTRACT

A hollow-core optical fiber including from 5 to 8 spaced apart cladding elements defining a hollow-core region, each including (a) a first capillary and (b) a second capillary disposed within the first capillary. For each of the cladding elements, (i) the second capillary is offset from the first capillary by an angle within a range of from 20 degrees to 120 degrees and (ii) a ratio of an outer diameter of the second capillary to an outer diameter of the first capillary is within a range of from 0.47 to 0.85. The hollow-core optical fiber exhibits confinement loss of less than 0.056 dB/km for electromagnetic radiation of 850 nm, less than 0.028 dB/km for electromagnetic radiation of 1310 nm, less than 0.204 dB/km for electromagnetic radiation of 1550 nm, and less than 0.016 dB/km for electromagnetic radiation of 2400 nm.

This application claims the benefit of priority under 35 U.S.C. § 120 of U.S. Provisional Application Ser. No. 63/469,677 filed on May 30, 2023, the content of which is relied upon and incorporated herein by reference in its entirety.

### TECHNICAL FIELD

This disclosure pertains to optical fibers and, more specifically, to optical fibers with an inner cladding of nested hollow capillaries to generate reduced confinement loss.

### BACKGROUND

An optical fiber is an optical waveguide that can transmit light signals over long distances. “Light” in this background section means electromagnetic radiation of the desired wavelength or wavelength range generally. Typically, data is encoded into the light signals. The optical fiber includes a core and a cladding around the core. The light signals are transmitted through the core and maintained within the core by different mechanisms. One such mechanism is based on internal reflection due to the difference in indices of refraction between the core and the cladding. Another such mechanism is based on a photonic band gap due to periodic structure of the cladding. A further mechanism is an anti-resonant mechanism based on an anti-resonant effect in the thin glass layer of the cladding. Despite these mechanisms, signal power of the light signals decreases as the light signals propagate along the optical fiber. The decrease in signal power is sometimes referred to as “signal loss,” and when quantified on a per distance basis, is referred to as “attenuation.” The greater the attenuation, the shorter the distance of data transmission, which then may require the incorporation of signal amplifiers to overcome the attenuation and provide light signals at the output end from which the intended data can be decoded. Causes of signal loss include absorption, scattering, the leaky nature of the modes and imperfect cladding (referred to as confinement loss), and leaks of light due to bending of the optical fiber (referred to as bending loss).

Various cladding design modifications have been considered to address the causes of signal loss, such as hollow-core optical fibers. Guiding light in hollow-core optical fibers has many theoretical benefits including lower loss due to material absorption and scattering. With a hollow-core optical fiber, the core is not a solid material like glass but rather is filled with gas (e.g., nitrogen or air). Being a gas rather than a solid, the light signals encounter less absorption and scattering. Thus, signal loss, in theory, should be reduced.

As an example to address confinement loss, hollow-core photonic bandgap optical fibers were developed. These optical fibers incorporate a cladding of hollow capillaries arranged in a periodic structure around the hollow core. The geometry of the capillaries and the spacing between them are predetermined to form a periodic variation in refractive index. The periodic variation in refractive index, in turn, creates a photonic bandgap that acts to prevent the transmission of light within a predetermined wavelength range through the cladding. The light of the predetermined wavelength range is therefore maintained within the hollow core thus decreasing confinement loss.

As another example, anti-resonant hollow-core optical fibers incorporate a single ring of anti-resonant tubes. The tubes are typically made of thin glass and are separated from each other by small air gaps. The thickness and separation of the tubes are predetermined to create an anti-resonant effect via destructive interference. The anti-resonant tubes reflects light back into the core.

To further reduce the confinement loss from the hollow core, hollow-core nested anti-resonant nodeless fibers (NANFs) are in development. Rather than single spaced apart tubes as in prior anti-resonant hollow core optical fibers, NANFs use larger tubes (e.g., larger capillaries) spaced radially around the core with at least one smaller tube (e.g., a smaller capillary) nested within each of the larger tubes. The spacing and geometry of the tubes are predetermined to cause destructive interference of the light waves and reflectance thereof back to the hollow core. Recent efforts take the concept further by placing an even smaller tube within each of the smaller tubes to generate a double-nested tube structure.

However, there is a problem in that hollow-core NANFs still generate a suboptimal amount of confinement loss, which leads to suboptimal amounts of attenuation over long distances. Double-nested tube structures may reduce confinement loss, but pose considerable manufacturing difficulties relative to the hollow-core NANF structure. There is a need for hollow-core NANFs with improved confinement loss.

### SUMMARY

The present disclosure addresses that need with a hollow-core optical fiber that includes 5 to 8 spaced apart cladding elements. Each of the cladding elements includes a first capillary and a second capillary nested with the first capillary. The first capillary of each cladding element is attached to an inner surface of a substrate. The second capillary is attached to the first capillary at an angle that is offset relative to a line extending through a central longitudinal axis of the hollow-core optical fiber, a longitudinal axis of the first capillary, and a region where the first capillary attaches to the substrate. The angle is within a range of from 20 degrees to 120 degrees. A ratio of an outer diameter of the second capillary to an outer diameter of the first capillary is within a range of from 0.47 to 0.85. Such a hollow-core optical fiber exhibits an extraordinarily low confinement loss for electromagnetic radiation having wavelengths in the near infrared and infrared ranges. The exhibited confinement loss is in some instances nearly an order of magnitude lower than previously reported conferment losses.

According to a first aspect of the present disclosure, a hollow-core optical fiber comprises: (1) a substrate that is tubular comprising an inner surface surrounding a central longitudinal axis of the hollow-core optical fiber; and (2) a plurality of cladding elements spaced apart from each other and disposed within the substrate, the plurality of cladding elements together defining a hollow-core region surrounding the central longitudinal axis of the hollow-core optical fiber with the plurality of cladding elements disposed radially between the substrate and the hollow-core region, each of the plurality of cladding elements extending parallel to the central longitudinal axis, and each of the plurality of cladding elements comprising (a) a first capillary that is tubular comprising (i) an outer surface having an outer diameter and contacting the inner surface of the substrate at a first contact region and (ii) an inner surface defining a first cavity with a first longitudinal axis parallel to the central longitudinal axis, and (b) a second capillary that is tubular disposed within the first cavity defined by the first capillary, the second capillary comprising (i) an outer surface having an outer diameter contacting the inner surface of the first capillary at a second contact region and (ii) an inner surface defining a second cavity with a second longitudinal axis parallel to the central longitudinal axis, wherein (i) for each of the plurality of cladding elements, a first line extends orthogonally from the central longitudinal axis through the first longitudinal axis and the first contact region, (ii) for each of the plurality of cladding elements, a second line extends through the second longitudinal axis, the second contact region, and the first longitudinal axis, (iii) for each of the plurality of cladding elements, the first line and the second line are separated by an angle that is within a range of from 20 degrees to 120 degrees, (iv) for each of the plurality of cladding elements, a ratio of the outer diameter of the second capillary to the outer diameter of the first capillary is within a range of from 0.47 to 0.85, and (v) the plurality of cladding elements numbers within a range of from 5 to 8.

According to a second aspect of the second disclosure, the hollow-core optical fiber of the first aspect is presented, wherein the inner surface of the substrate comprises an inner diameter that is within a range of from 30 μm to 140 μm.

According to a third aspect of the present disclosure, the hollow-core optical fiber of any one of the first through second aspects is presented, wherein the plurality of cladding elements numbers 6.

According to a fourth aspect of the present disclosure, the hollow-core optical fiber of any one of the first through third aspects is presented, wherein the hollow-core region comprises air or nitrogen.

According to a fifth aspect of the present disclosure, the hollow-core optical fiber of any one of the first through fourth aspects is presented, wherein for each of the plurality of cladding elements, the outer diameter of the first capillary is within a range of from 8 μm to 52 μm.

According to a sixth aspect of the present disclosure, the hollow-core optical fiber of any one of the first through fifth aspects is presented, wherein for each of the plurality of cladding elements, the outer diameter of the first capillary is within a range of from 25 μm to 35 μm.

According to a seventh aspect of the present disclosure, the hollow-core optical fiber of any one of the first through sixth aspects is presented, wherein the first capillaries are evenly spaced from each other.

According to an eighth aspect of the present disclosure, the hollow-core optical fiber of any one of the first through seventh aspects is presented, wherein the first capillaries of adjacent cladding elements of the plurality of cladding elements are separated by a shortest distance that is within a range of from 1.8 μm to 6.0 μm.

According to a ninth aspect of the present disclosure, the hollow-core optical fiber of the eight aspect is presented, wherein (i) for each of the plurality of cladding elements, the first capillary has a thickness, and (ii) a ratio of the shortest distance to the thickness of the first capillary is within a range of from 5 to 7.

According to a tenth aspect of the present disclosure, the hollow-core optical fiber of any one of the first through eighth aspects is presented, wherein for each of the plurality of cladding elements, the first capillary and the second capillary both have a thickness that is within a range of from 0.20 μm to 2.0 μm.

According to an eleventh aspect of the present disclosure, the hollow-core optical fiber of any one of the first through tenth aspects is presented, wherein the hollow-core region has an effective diameter within a range of from 10 μm to 60 μm.

According to a twelfth aspect of the present disclosure, the hollow-core optical fiber of any one of the first through tenth aspects is presented, wherein the hollow-core region has an effective diameter within a range of from 25 μm to 35 μm.

According to a thirteenth aspect of the present disclosure, the hollow-core optical fiber of any one of the first through twelfth aspects is presented, wherein for each of the plurality of cladding elements, the outer diameter of the second capillary is greater than 12 μm.

According to a fourteenth aspect of the present disclosure, the hollow-core optical fiber of any one of the first through thirteenth aspects is presented, wherein for each of the plurality of cladding elements, the outer diameter of the second capillary is within a range of from 13 μm to 24 μm.

According to a fifteenth aspect of the present disclosure, the hollow-core optical fiber of any one of the first through fourteenth aspects is presented, wherein for each of the plurality of cladding elements, a ratio of the outer diameter of the second capillary to the inner diameter of the inner surface of the substrate is within a range of from 0.14 to 0.25.

According to a sixteenth aspect of the present disclosure, the hollow-core optical fiber of the fifteenth aspect is presented, wherein the ratio of the outer diameter of the second capillary to the inner diameter of the inner surface of the substrate is within a range of from 0.16 to 0.23.

According to a seventeenth aspect of the present disclosure, the hollow-core optical fiber of any one of the first through sixteenth aspects is presented, wherein for each of the plurality of cladding elements, the ratio of the outer diameter of the second capillary to the outer diameter of the first capillary is within a range of from 0.60 to 0.72.

According to an eighteenth aspect of the present disclosure, the hollow-core optical fiber of any one of the first through seventeenth aspects is presented, wherein none of the plurality of cladding elements further includes another capillary disposed within the second cavity that that the second capillary forms.

According to a nineteenth aspect of the present disclosure, the hollow-core optical fiber of any one of the first through eighteenth aspects is presented, wherein for each of the plurality of cladding elements, the first capillary and the second capillary comprises silica glass or doped silica glass.

According to a twentieth aspect of the present disclosure, the hollow-core optical fiber of any one of the first through nineteenth aspects is presented, wherein for each of the plurality of cladding elements, the first capillary and the second capillary both have an index of refraction that is within a range of from 1.4 to 2.8 for electromagnetic radiation having a wavelength of 589.3 nm at room temperature.

According to a twenty-first aspect of the present disclosure, the hollow-core optical fiber of any one of the first through twentieth aspects is presented, wherein for each of the plurality of cladding elements, the angle separating the first line and the second line is within a range of from 60 degrees to 110 degrees.

According to a twenty-second aspect of the present disclosure, the hollow-core optical fiber of the twenty-first aspect is presented, wherein the angle is within a range of from 80 degrees to 100 degrees.

According to a twenty-third aspect of the present disclosure, the hollow-core optical fiber of the twenty-second aspect is presented, wherein the angle is within a range of from 85 degrees to 95 degrees.

According to a twenty-fourth aspect of the present disclosure, the hollow-core optical fiber of any one of the first through twenty-third aspects is presented, wherein (i) the outer diameters of the first capillaries of each of the plurality of cladding elements are approximately the same, (ii) the outer diameters of the second capillaries of each of the plurality of cladding elements approximately the same, and (iii) the angles separating the first line and the second line of each of the plurality of cladding elements are approximately the same.

According to a twenty-fifth aspect of the present disclosure, the hollow-core optical fiber of any one of the first through twenty-first aspects is presented, wherein (i) for each of the plurality of cladding elements, the angle separating the first line and the second line is within a range of from 80 degrees to 105 degrees, and (ii) for each of the plurality of cladding elements, the outer diameter of the second capillary is within a range of from 17 μm to 19 μm.

According to a twenty-sixth aspect of the present disclosure, the hollow-core optical fiber of any one of the first through twenty-fifth aspects is presented, wherein the hollow-core optical fiber exhibits a confinement loss of less than 1 dB/km for electromagnetic radiation having a wavelength of 1550 nm.

According to a twenty-seventh aspect of the present disclosure, the hollow-core optical fiber of the twenty-sixth aspect is presented, wherein the hollow-core optical fiber exhibits a confinement loss of less than 0.5 dB/km for electromagnetic radiation having a wavelength of 1550 nm.

According to a twenty-eighth aspect of the present disclosure, the hollow-core optical fiber of the twenty-seventh aspect is presented, wherein the hollow-core optical fiber exhibits a confinement loss of less than 0.1 dB/km for electromagnetic radiation having a wavelength of 1550 nm.

According to a twenty-ninth aspect of the present disclosure, the hollow-core optical fiber of the twenty-eighth aspect is presented, wherein the hollow-core optical fiber exhibits a confinement loss of less than 0.05 dB/km for electromagnetic radiation having a wavelength of 1550 nm.

According to a thirtieth aspect of the present disclosure, the hollow-core optical fiber of any one first through fourth aspects is presented, wherein (a) the hollow-core region has an effective diameter within a range of from 17 μm to 21 μm; and (b) for each of the plurality of cladding elements (i) the outer diameter of the first capillary is within a range of from 13 μm to 17 μm; (ii) the outer diameter of the second capillary is within a range of from 8.5 μm to 11.5 μm; (iii) the first capillary and the second capillary both have a thickness within a range of from 0.25 μm to 0.35 μm; and (iv) the angle separating the first line and the second line is within a range of from 40 degrees to 120 degrees.

According to a thirty-first aspect of the present disclosure, the hollow-core optical fiber of the thirtieth aspect is presented, wherein the hollow-core optical fiber exhibits a confinement loss of less than 0.16 dB/km for electromagnetic radiation having a wavelength of 1550 nm

According to a thirty-second aspect of the present disclosure, the hollow-core optical fiber of any one of the first through fourth aspects is presented, wherein (a) the hollow-core region has an effective diameter within a range of from 26 μm to 32 μm, and, (b) for each of the plurality of cladding elements (i) the outer diameter of the first capillary is within a range of from 20 μm to 26 μm; (ii) the outer diameter of the second capillary is within a range of from 12 μm to 18 μm; (iii) the first capillary and the second capillary both have a thickness within a range of from 0.38 μm to 0.48 μm; and (iv) the angle separating the first line and the second line is within a range of from 20 degrees to 120 degrees.

According to a thirty-third aspect of the present disclosure, the hollow-core optical fiber of the thirty-second aspect is presented, wherein the hollow-core optical fiber exhibits a confinement loss of less than 0.16 dB/km for electromagnetic radiation having a wavelength of 1310 nm.

According to a thirty-fourth aspect of the present disclosure, the hollow-core optical fiber of any one of the first through fourth aspects is presented, wherein (a) the hollow-core region has an effective diameter within a range of from 31 μm to 37 μm; and, (b) for each of the plurality of cladding elements (i) the outer diameter of the first capillary is within a range of from 23 μm to 31 μm; (ii) the outer diameter of the second capillary is within a range of from 15 μm to 21 μm; (iii) the first capillary and the second capillary both have a thickness within a range of from 0.4 μm to 0.6 μm; and (iv) the angle separating the first line and the second line is within a range of from 40 degrees to 110 degrees.

According to a thirty-fifth aspect of the present disclosure, the thirty-fourth aspect is presented, wherein the hollow-core optical fiber exhibits a confinement loss of less than 0.16 dB/km for electromagnetic radiation having a wavelength of 1550 nm.

According to a thirty-sixth aspect of the present disclosure, any one of the first through fourth aspects is presented, wherein (a) the hollow-core region has an effective diameter within a range of from 50 μm to 56 μm; and, (b) for each of the plurality of cladding elements (i) the outer diameter of the first capillary is within a range of from 39 μm to 45 μm; (ii) the outer diameter of the second capillary is within a range of from 23 μm to 32 μm; (iii) the first capillary and the second capillary both have a thickness within a range of from 0.7 μm to 0.9 μm; and (iv) the angle separating the first line and the second line is within a range of from 35 degrees to 110 degrees.

According to a thirty-seventh aspect of the present disclosure, the hollow-core optical fiber of the thirty-sixth aspect is presented, wherein the hollow-core optical fiber exhibits a confinement loss of less than 0.16 dB/km for electromagnetic radiation having a wavelength of 2400 nm.

According to a thirty-eighth aspect of the present disclosure, the hollow-core optical fiber of any one of the first through fourth aspects is presented, wherein (a) the hollow-core region has an effective diameter within a range of from 22 μm to 28 μm and, (b) for each of the plurality of cladding elements (i) the outer diameter of the first capillary is within a range of from 17 μm to 23 μm; (ii) the outer diameter of the second capillary is within a range of from 10 μm to 15 μm; (iii) the first capillary and the second capillary both have a thickness within a range of from 0.4 μm to 0.6 μm; and (iv) the angle separating the first line and the second line is within a range of from 40 degrees to 110 degrees.

According to a thirty-ninth aspect of the present disclosure, the hollow-core optical fiber of the thirty-eighth aspect is presented, wherein the hollow-core optical fiber exhibits a confinement loss of less than 0.26 dB/km for electromagnetic radiation having a wavelength of 1550 nm.

According to a fortieth aspect of the present disclosure, a hollow-core optical fiber comprises: (1) a substrate that is tubular comprising an inner surface surrounding a central longitudinal axis of the hollow-core optical fiber; and (2) a plurality of cladding elements spaced apart from each other and disposed within the substrate, the plurality of cladding elements together defining a hollow-core region surrounding the central longitudinal axis of the hollow-core optical fiber with the plurality of cladding elements disposed radially between the substrate and the hollow-core region, each of the plurality of cladding elements extending parallel to the central longitudinal axis, and each of the plurality of cladding elements comprising (a) a first capillary that is tubular comprising (i) an outer surface having an outer diameter and contacting the inner surface of the substrate at a first contact region and (ii) an inner surface defining a first cavity with a first longitudinal axis parallel to the central longitudinal axis, and (b) a second capillary that is tubular disposed within the first cavity defined by the first capillary, the second capillary comprising (i) an outer surface having an outer diameter and contacting the inner surface of the first capillary at a second contact region and (ii) an inner surface defining a second cavity with a second longitudinal axis parallel to the central longitudinal axis, wherein (i) for each of plurality of cladding elements, a first line extends orthogonally from the central longitudinal axis through the first longitudinal axis and the first contact region, (ii) for each of the plurality of cladding elements, a second line extends through the second longitudinal axis, the second contact region and, the first longitudinal axis, (iii) for each of the plurality of cladding elements, the first line and the second line are separated by an angle that is within a range of from 20 degrees to 120 degrees, (iv) the inner surface of the substrate comprises a inner diameter that is within a range of from 26 μm to 164 μm, (v) for each of the plurality of cladding elements, a ratio of the outer diameter of the second capillary to the inner diameter of the inner surface of the substrate is within a range of from 0.14 to 0.25, and (vi) the plurality of cladding elements numbers within a range of from 5 to 8.

According to a forty-first aspect of the present disclosure, a hollow-core optical fiber comprises: (1) a substrate that is tubular comprising an inner surface surrounding a central longitudinal axis of the hollow-core optical fiber; and (2) a plurality of cladding elements spaced apart from each other and disposed within the substrate, the plurality of cladding elements together defining a hollow-core region surrounding the central longitudinal axis of the hollow-core optical fiber with the plurality of cladding elements disposed radially between the substrate and the hollow-core region, each of the plurality of cladding elements extending parallel to the central longitudinal axis, and each of the plurality of cladding element comprising (a) a first capillary that is tubular comprising (i) an outer surface having an outer diameter and contacting the inner surface of the substrate at a first contact region and (ii) an inner surface defining a first cavity with a first longitudinal axis parallel to the central longitudinal axis, and (b) a second capillary that is tubular disposed within the first cavity defined by the first capillary, the second capillary comprising (i) an outer surface having an outer diameter and contacting the inner surface of the first capillary at a second contact region and (ii) an inner surface defining a second cavity with a second longitudinal axis parallel to the central longitudinal axis, wherein (i) for each of plurality of cladding elements, a first line extends orthogonally from the central longitudinal axis through the first longitudinal axis and the first contact region, (ii) for each of the plurality of cladding elements, a second line extends through the second longitudinal axis, the second contact region and, the first longitudinal axis, (iii) for each of the plurality of cladding elements, the first line and the second line are separated by an angle that is within a range of from 20 degrees to 120 degrees, (iv) the hollow-core region has an effective diameter within a range of from 10 μm to 40 μm, (v) for each of the plurality of cladding elements the outer diameter of the first capillary is within a range of from 8 μm to 52 μm, (vi) for each of the plurality of cladding elements, the first capillary and the second capillary both have a thickness within a range of from 0.20 μm to 2.0 μm, and (vii) the plurality of cladding elements numbers within a range of from 5 to 8.

### BRIEF DESCRIPTION OF THE DRAWINGS

In the Drawings:

FIG. 1 is an elevational view of a hollow-core optical fiber of the present disclosure, illustrating a central longitudinal axis of the hollow-core optical fiber and a substrate extending longitudinally along the central longitudinal axis from a first end to a second end of the hollow-core optical fiber;

FIG. 2 is an elevational view of a cross-section of the hollow-core optical fiber of FIG. 1 taken through line II-II of FIG. 1, illustrating the hollow-core optical fiber further including a plurality of cladding elements that are spaced apart from each other and each having a first capillary and a second capillary nested within the first capillary;

FIG. 3, pertaining to an Example 1, is a map of confinement loss of a cross-section of a hollow-core optical fiber of the present disclosure as calculated via a computer model;

FIG. 4, pertaining to an Example 2, is a graph plotting confinement loss as determined by the computer model for a hollow-core optical fiber of the present disclosure as a function of (i) an angle by which the second capillary is offset within the first capillary and (ii) an outer diameter of the second capillary of each of the plurality of cladding elements, illustrating that the larger the outer diameter, the less the confinement loss;

FIG. 5, pertaining to Example 2, is a graph plotting confinement loss as a function of the angle and the outer diameter of the second capillary of each of the plurality of cladding elements, illustrating that the modeled hollow-core optical fiber exhibits the lowest confinement loss when the second outer was greater than or equal to about 15 μm and the angle was within a range of from about 25 degrees to about 120 degrees;

FIG. 6, pertaining to an Example 3, is a graph plotting confinement loss, as determined by the computer model for a hollow-core optical fiber of the present disclosure, as a function of the angle and the outer diameter of the second capillary of each of the plurality of cladding elements;

FIG. 7, pertaining to an Example 4, is a graph plotting confinement loss, as determined by the computer model for a hollow-core optical fiber of the present disclosure, as a function of the angle and the outer diameter of the second capillary of each of the plurality of cladding elements;

FIG. 8A, pertaining to an Example 5, is a graph plotting confinement loss, as determined by the computer model for a hollow-core optical fiber of the present disclosure, as a function of the angle and the outer diameter of the second capillary of each of the plurality of cladding elements;

FIG. 8B, pertaining to Example 5, is a graph plotting confinement loss as a function of a ratio of the outer diameter of the second (smaller) capillary to the outer diameter of the first (larger) capillary;

FIG. 8C, pertaining to Example 5, is a graph plotting confinement loss as a function of angle;

FIG. 9, pertaining to an Example 6, is a graph plotting confinement loss, as determined by the computer model for a hollow-core optical fiber of the present disclosure, as a function of the angle and the outer diameter of the second capillary of each of the plurality of cladding elements;

FIG. 10, pertaining to an Example 7, is a graph plotting confinement loss, as determined by the computer model for a hollow-core optical fiber of the present disclosure, as a function of the angle and the outer diameter of the second capillary of each of the plurality of cladding elements; and

FIG. 11, pertaining to an Example 8, is a graph plotting confinement loss, as determined by the computer model for a hollow-core optical fiber of the present disclosure, as a function of the angle and the outer diameter of the second capillary of each of the plurality of cladding elements.

### DETAILED DESCRIPTION

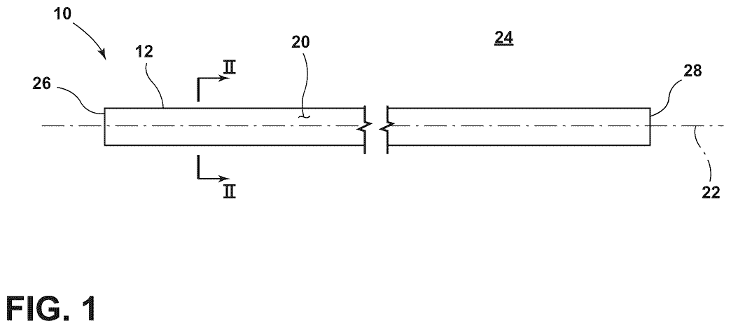

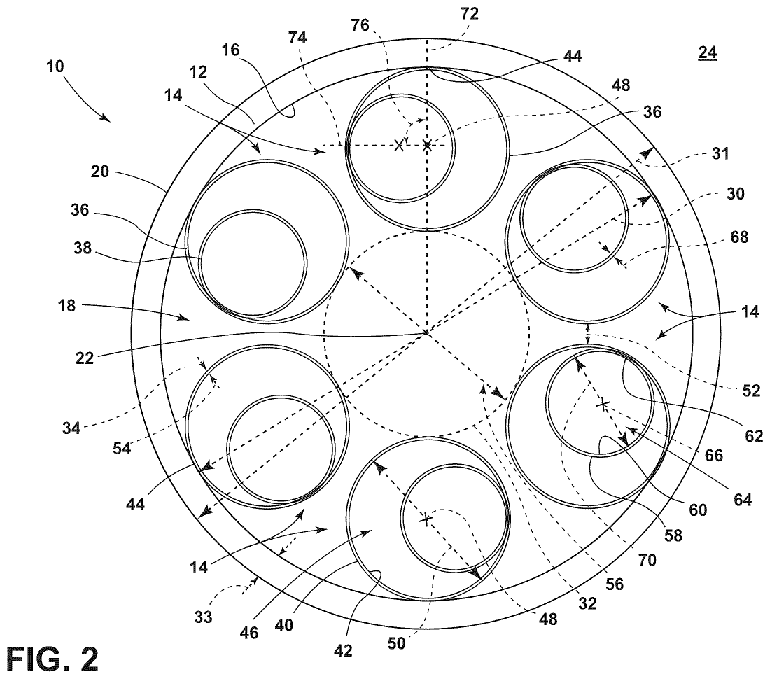

Referring to FIGS. 1-2, a hollow-core optical fiber 10 includes a substrate 12 and a plurality of cladding elements 14. The substrate 12 is tubular with an inner surface 16, which forms a cavity 18, and an outer surface 20. The inner surface 16 surrounds a central longitudinal axis 22 of the hollow-core optical fiber 10. The outer surface 20 faces toward an external environment 24. The substrate 12, and the cavity 18 that it forms, extends longitudinally from a first end 26 to a second end 28. The inner surface 16 has an inner diameter 30. The outer surface 20 has an outer diameter 31. In embodiments, the inner diameter 30 of the substrate 12 is within a range of from 26 μm to 164 μm. In embodiments, the inner diameter 30 is 26 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, or 164 μm, or within any range bound by any two of those values (e.g., from 55 μm to 130 μm, from 90 μm to 135 μm, from 30 μm to 140 μm, and so on). In embodiments, the outer diameter 31 of the substrate 12 is within a range of from 46 μm to 364 μm. In embodiments, the outer diameter 31 is 46 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, or 364 μm, or within any range bound by any two of those values (e.g., from 110 μm to 240 μm, from 60 μm to 320 μm, and so on). The substrate 12 has a thickness 33 between the inner surface 16 and the outer surface 20. In embodiments, the thickness 33 of the substrate 12 is within a range of from 10 μm to 100 μm. In embodiments, the thickness 33 is 10 μm, 20 μm, 30 μm, 40 μm, 50 μm, 60 μm, 70 μm, 80 μm, 90 μm, or 100 μm, or within any range bound by any two of those values (e.g., from 20 μm to 90 μm, from 30 μm to 70 μm, and so on).

The plurality of cladding elements 14 are disposed within the cavity 18 of the substrate 12. The plurality of cladding elements 14 extend longitudinally within the cavity 18 of the substrate 12 parallel to the central longitudinal axis 22 of the hollow-core optical fiber 10. The plurality of cladding elements 14 are spaced apart from each other and are positioned radially around the central longitudinal axis 22. For example, none of the plurality of cladding elements 14 touches another one of the plurality of cladding elements 14. The plurality of cladding elements 14 numbers within a range of from 5 to 8. In embodiments, the hollow-core optical fiber 10 includes 5, 6, 7, or 8 cladding elements 14.

The plurality of cladding elements 14 together define a hollow-core region 32. The hollow-core region 32 radially surrounds the central longitudinal axis 22 and extends longitudinally parallel to the central longitudinal axis 22. The plurality of cladding elements 14 are disposed radially between the substrate 12 and the hollow-core region 32. The hollow-core region 32 is not a physical component, such as a tubular core, but rather is where electromagnetic radiation is largely confined by the plurality of cladding elements 14 and transmits longitudinally within the hollow-core optical fiber 10. The plurality of cladding elements 14 maintain the electromagnetic radiation largely within the hollow-core region 32 due to anti-resonance. The cavity 18 within the substrate 12 not occupied by the plurality of cladding elements 14, including the hollow-core region 32, comprises a gas 34. In embodiments, the gas 34 is air or nitrogen.

Each of the plurality of cladding elements 14 includes a first capillary 36 and a second capillary 38 nested with the first capillary 36. Both the first capillary 36 and the second capillary 38 are tubular and extend longitudinally parallel to the central longitudinal axis 22. The first capillary 36 includes an outer surface 40 and an inner surface 42. The outer surface 40 contacts the inner surface 16 of the substrate 12, and can be attached thereto, at a first contact region 44. The inner surface 42 defines a first cavity 46 with a first longitudinal axis 48 that is parallel to the central longitudinal axis 22 of the hollow-core optical fiber 10.

The outer surface 40 of the first capillary 36 of each of the plurality of cladding elements 14 has an outer diameter 50. In embodiments, the outer diameter 50 is within a range of from 8 μm to 52 μm. In embodiments, the outer diameter 50 is 8 μm, 10 μm, 12 μm, 15 μm, 20 μm, 25 μm, 30 μm, 35 μm, 40 μm, 45 μm, 46 μm, 50 μm, or 52 μm, or within any range bound by any two of those values (e.g., from 25 μm to 35 μm, from 20 μm to 40 μm, from 12 μm to 46 μm, and so on). The outer diameter 50 of the first capillary 36 of each of the plurality of cladding element 14 are all approximately the same, meaning that the hollow-core optical fiber 10 is manufactured with the intention that the outer diameter 50 of all of the first capillaries 36 are the same, while recognizing that there will be some variation in the outer diameter 50 among the first capillaries 36 due to manufacturing imprecision. In embodiments, the outer diameters 50 are all within a tolerance of +/−10% from an average of the outer diameters 50.

As mentioned, none of the plurality of cladding elements 14 touch each other and, as such, none of the first capillaries 36 touch each other. Each of the first capillaries 36 is separated from adjacent first capillaries 36 by a shortest distance 52 (from outer surface 40 to outer surface 40). In embodiments, the shortest distance 52 is within a range of from 1.8 μm to 6.0 μm. In embodiments, the shortest distance 52 is 1.8 μm, 2.0 μm, 2.5 μm, 3.0 μm, 3.5 μm, 4.0 μm, 4.5 μm, 5.0 μm, 5.5 μm, or 6.0 μm, or within any range bound by any two of those values (e.g., from 2.0 μm to 4.5 μm, from 2.5 μm to 5.5 μm, and so on). The shortest distances 52 separating adjacent first capillaries 36 are all approximately the same, meaning that the hollow-core optical fiber 10 is manufactured with the intention that the shortest distances 52 are all the same and the first capillaries 36 are evenly spaced from each other, while recognizing that there will be some variation in the shortest distances 52 due to manufacturing imprecision. In embodiments, the shortest distances 52 are all within a tolerance of +/−10% from an average of the shortest distances 52.

Each of the first capillaries 36 has a thickness 54. The thickness 54 is distance between the outer surface 40 and the inner surface 42. In embodiments, the thickness 54 is within a range of from 0.20 μm to 2.00 μm. In embodiments, the thickness 54 is 0.20 μm, 0.50 μm, 0.75 μm, 1.00 μm, 1.25 μm, 1.50 μm, 1.75 μm, or 2.00 μm, or within any range bound by any two of those values (e.g., from 0.50 μm to 1.50 μm, from 0.20 μm to 1.75 μm, and so on). The thicknesses 54 of the first capillaries 36 are all approximately the same, meaning that the hollow-core optical fiber 10 is manufactured with the intention that the thicknesses 54 are all the same, while recognizing that there will be some variation in the thicknesses 54 due to manufacturing imprecision. In embodiments, the thicknesses 54 are all within a tolerance of +/−10% from an average of the thicknesses 54. In embodiments, a ratio of (i) the shortest distance 52 separating adjacent of the first capillaries 36 to (ii) the thickness 54 of the first capillaries 36 is within a range of from 5 to 7.

The hollow-core region 32 has an effective diameter 56. The effective diameter 56 extends through the central longitudinal axis 22 and is bound by the outer surfaces 40 of the first capillaries 36 of the plurality of cladding elements 14. The effective diameter 56 abuts but does not intersect with the outer surfaces 40. In embodiments, the effective diameter 56 of the hollow-core region 32 is within a range of from 10 μm to 60 μm. In embodiments, the effective diameter 56 is 10 μm, 15 μm, 20 μm, 25 μm, 30 μm, 35 μm, 40 μm, 45 μm, 50 μm, 55 μm, or 60 μm, or within any range bound by any two of those values (e.g., from 10 μm to 40 μm, from 25 μm to 35 μm, from 15 μm to 55 μm, and so on).

As mentioned, each of plurality of cladding elements 14 further includes the second capillary 38 nested within the first capillary 36. The second capillary 38 of any one of the plurality of cladding elements 14 is disposed within the first cavity 46 defined by the first capillary 36 of the cladding element 14. Each of the first capillaries 36 has one of the second capillaries 38 disposed therein. Each second capillary 38 has an outer surface 58 and an inner surface 60. For each of the plurality of cladding elements 14, the outer surface 58 of the second capillary 38 contacts the inner surface 42 of the first capillary 36 within which the second capillary 38 is disposed at a second contact region 62. The second capillary 38 can be attached to the first capillary 36 at the second contact region 62. The inner surface 60 defines a second cavity 64 with a second longitudinal axis 66 that is parallel to the central longitudinal axis 22 of the hollow-core optical fiber 10.

Each second capillary 38 has a thickness 68. The thickness 68 is the shortest distance between the outer surface 58 and the inner surface 60. In embodiments, the thickness 68 is within a range of from 0.20 μm to 2.00 μm. In embodiments, the thickness 68 is 0.20 μm, 0.50 μm, 0.75 μm, 1.00 μm, 1.25 μm, 1.50 μm, 1.75 μm, or 2.00 μm, or within any range bound by any two of those values (e.g., from 0.50 μm to 1.50 μm, from 0.20 μm to 1.75 μm, and so on). The thicknesses 68 of the second capillaries 38 are all approximately the same, meaning that the hollow-core optical fiber 10 is manufactured with the intention that the thickness 68 are all the same, while recognizing that there will be some variation in the thicknesses 68 due to manufacturing imprecision. In embodiments, the thicknesses 68 are all within a tolerance of +/−10% from an average of the thicknesses 68.

The second capillary 38 of each of the plurality of cladding elements 14 has an outer diameter 70 defined by the outer surface 58. The outer diameter 70 is smaller than the outer diameter 50 of the first capillary 36 within which the second capillary 38 is disposed. In embodiments, the outer diameter 70 of each of the second capillaries 38 is greater than 12 μm. In embodiments, the outer diameter 70 of each of the second capillaries 38 is 12 μm, 13 μm, 14 μm, 15 μm, 16 μm, 17 μm, 18 μm, 19 μm, 20 μm, 21 μm, 22 μm, 23 μm, or 24 μm, or within any range bound by any two of those values (e.g., from 13 μm to 24 μm, from 15 μm to 19 μm, and so on). The outer diameters 70 of the second capillaries 38 are all approximately the same, meaning that the hollow-core optical fiber 10 is manufactured with the intention that the outer diameters 70 are all the same, while recognizing that there will be some variation in the outer diameters 70 due to manufacturing imprecision. In embodiments, the outer diameters 70 are all within a tolerance of +/−10% from an average of the outer diameters 70.

In embodiments, a ratio of (i) the outer diameter 70 of each of the second capillaries 38 to (ii) the inner diameter 30 of the inner surface 16 of the substrate 12 is within a range of from 0.14 to 0.25. In embodiments, the ratio is 0.14, 0.15, 0.16, 0.17, 0.18, 0.19, 0.20, 0.21, 0.22, 0.23, 0.24, or 0.25, or within any range bound by any two of those values (e.g., from 016 to 0.23, from 0.18 to 0.22, and so on).

In embodiments, for each of the plurality of cladding elements 14, a ratio of (i) the outer diameter 70 of the second capillary 38 to (ii) the outer diameter 50 of the first capillary 36 is within a range of from 0.47 to 0.85. In embodiments, the range is 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, or 0.85, or within any range bound by any two of those values (e.g., from 0.60 to 0.72, 0.62 to 0.69, from 0.64, to 0.71, and so on).

In embodiments, the hollow-core optical fiber 10 is not a double-nested hollow-core optical fiber 10. For example, none of the plurality of cladding elements 14 further includes another capillary disposed within the second cavity 64 that that the second capillary 38 forms. In other embodiments, each of the plurality of cladding elements 14 further includes one or more capillaries (not separately illustrated) within the second cavity 64 that the second capillary 38 forms.

In embodiment, the first capillary 36 and the second capillary 38 of each of the plurality of cladding elements 14 includes (e.g., is made of) glass, such as silica glass, modified silica glass, or doped silica glass. In embodiments, each of the first capillaries 36 and the second capillaries 38 of the plurality of cladding elements 14 has an index of refraction that is within a range of from 1.4 to 2.8 for electromagnetic radiation having a wavelength of 589.3 nm at room temperature. Other compositions for the first capillary 36 and the second capillary 38 are envisioned.

For each of the plurality of cladding elements 14, a first line 72 extends orthogonally from the central longitudinal axis 22 through the first longitudinal axis 48 and the first contact region 44. Further, for each of the plurality of cladding elements 14, a second line 74 extends orthogonally through the second longitudinal axis 66 and intersects with the first longitudinal axis 48 and the second contact region 62. The first line 72 and the second line 74 are conceptual references to help explain what follows and are not structural components.

For each of the plurality of cladding elements 14, the first line 72 and the second line 74 are separated by an angle 76. The angle 76 is within a range of from 20 degrees to 120 degrees. In embodiments, the angle 76 is 20 degrees, 30 degrees, 40 degrees, 50 degrees, 60 degrees, 70 degrees, 80 degrees, 90 degrees, 100 degrees, or 110 degrees, or within any range bound by any two of those values (e.g., from 60 degrees to 110 degrees, from 80 degrees to 100 degrees, from 85 degrees to 95 degrees, and so on). The angles 76 separating the first line 72 and the second line 74 for each of the plurality of cladding elements 14 are approximately the same, meaning that the hollow-core optical fiber 10 is manufactured with the intention that the angles 76 are all the same, while recognizing that there will be some variation in the angles 76 due to manufacturing imprecision. In embodiments, the angles 76 are all within a tolerance of +/−10% from an average of the angles 76. In embodiments, for each of the cladding elements 14, (i) the angle 76 separating the first line 72 and the second line 74 is within a range of from 80 degrees to 105 degrees, and (ii) the outer diameter 70 of the second capillary 38 is within a range of from 17 μm to 19 μm.

The hollow-core optical fiber 10 described herein exhibits very low confinement loss, especially of electromagnetic radiation having a wavelength within a range of from about 850 nm to about 2400 nm and beyond. In embodiments, the hollow-core optical fiber 10 exhibits a confinement loss of less than 1 dB/km of for electromagnetic radiation having a wavelength of 1550 nm. In embodiments, the hollow-core optical fiber 10 exhibits a confinement loss of less than 0.5 dB/km of for electromagnetic radiation having a wavelength of 1550 nm. In embodiments, the hollow-core optical fiber 10 exhibits a confinement loss of less than 0.1 dB/km of for electromagnetic radiation having a wavelength of 1550 nm. In embodiments, the hollow-core optical fiber 10 exhibits a confinement loss of less than 0.05 dB/km of for electromagnetic radiation having a wavelength of 1550 nm. Confinement loss of a physical hollow-core optical fiber can be estimated by taking a cross-section of the hollow-core optical fiber, measuring the components (such as with a scanning-electron microscope), and inputting the measured values into mode solver software program, such as COMSOL® Multiphysics with the Wave Optics Module. The software program may employ the finite difference method to solve the wave equation governing light propagation and generate the effective index of the optical m^{th}-mode (n_{eff,m}). The effective index (n_{eff,m}) can be expressed as a complex number with real and imaginary parts via equation (1) below.

$${n}_{eff , m} = {n}_{re , m} + i \cdot {n}_{l m , m} . \qquad ( 1 )$$

Confinement loss can be calculated from the imaginary part using the equation (2) below, where λ is the wavelength in meters.

$${α}_{C L , m} ( \frac{dB}{km} ) = \frac{20}{ln ( 10 )} \frac{2 π}{λ} \times {n}_{l m , m} \times 1 {0}^{3} . \qquad ( 2 )$$

As another example, the effective diameter 56 of the hollow-core region 32 is within a range of from 17 μm to 21 μm and, for each of the plurality of cladding elements 14, (i) the outer diameter 50 of the first capillary 36 is within a range of from 13 μm to 17 μm, (ii) the outer diameter 70 of the second capillary 38 is within a range of from 8.5 μm to 11.5 μm, (iii) the thicknesses 54, 68 of the first capillary 36 and the second capillary 38 are both within a range of from 0.25 μm to 0.35 μm, and (iv) the angle 76 separating the first line 72 and the second line 74 is within a range of from 40 degrees to 120 degrees. The hollow-core optical fiber 10 as described can exhibit a confinement loss of less than 0.16 dB/km for electromagnetic radiation having a wavelength of 1550 nm.

As another example, the effective diameter 56 of the hollow-core region 32 is within a range of from 26 μm to 32 μm, and, for each of the plurality of cladding elements 14 (i) the outer diameter 50 of the first capillary 36 is within a range of from 20 μm to 26 μm, (ii) the outer diameter 70 of the second capillary 38 is within a range of from 12 μm to 18 μm, (iii) the thicknesses 54, 68 of the first capillary 36 and the second capillary 38 are both within a range of from 0.38 μm to 0.48 μm, and (iv) the angle 76 separating the first line 72 and the second line 74 is within a range of from 20 degrees to 120 degrees. The hollow-core optical fiber 10 as described can exhibit a confinement loss of less than 0.16 dB/km for electromagnetic radiation having a wavelength of 1310 nm.

As another example, the effective diameter 56 of the hollow-core region 32 is within a range of from 31 μm to 37 μm, and, for each of the plurality of cladding elements 14 (i) the outer diameter 50 of the first capillary 36 is within a range of from 23 μm to 31 μm, (ii) the outer diameter 70 of the second capillary 38 is within a range of from 15 μm to 21 μm, (iii) the thicknesses 54, 68 of the first capillary 36 and the second capillary 38 are both within a range of from 0.40 μm to 0.60 μm, and (iv) the angle 76 separating the first line 72 and the second line 74 is within a range of from 40 degrees to 110 degrees. The hollow-core optical fiber 10 as described can exhibit a confinement loss of less than 0.16 dB/km for electromagnetic radiation having a wavelength of 1550 nm.

As another example, the effective diameter 56 of the hollow-core region 32 is within a range of from 50 μm to 56 μm and, for each of the plurality of cladding elements 14 (i) the outer diameter 50 of the first capillary 36 is within a range of from 39 μm to 45 μm, (ii) the outer diameter 70 of the second capillary 38 is within a range of from 23 μm to 32 μm, (iii) the thicknesses 54, 68 of the first capillary 36 and the second capillary 38 are both within a range of from 0.70 μm to 0.90 μm, and (iv) the angle 76 separating the first line 72 and the second line 74 is within a range of from 35 degrees to 110 degrees. The hollow-core optical fiber 10 as described can exhibit a confinement loss of less than 0.16 dB/km for electromagnetic radiation having a wavelength of 2400 nm.

As another example, the effective diameter 56 of the hollow-core region 32 is within a range of from 22 μm to 28 μm and, for each of the plurality of cladding elements 14, (i) the outer diameter 50 of the first capillary 36 is within a range of from 17 μm to 23 μm, (ii) the outer diameter 70 of the second capillary 38 is within a range of from 10 μm to 15 μm, (iii) the thicknesses 54, 68 of the first capillary 36 and the second capillary 38 are both within a range of from 0.40 μm to 0.60 μm, and (iv) the angle 76 separating the first line 72 and the second line 74 is within a range of from 40 degrees to 110 degrees. The hollow-core optical fiber 10 as described can exhibit a confinement loss of less than 0.26 dB/km for electromagnetic radiation having a wavelength of 1550 nm.

The hollow-core optical fiber 10 of the present disclosure addresses the aforementioned need by exhibiting extraordinarily low confinement loss. The extraordinarily low confinement loss includes low confinement loss for the fundament mode. The plurality of cladding elements 14 with the second capillary 38 contacting the first capillary 36 at the second contact region 62 that is angularly offset from the first contact region 44 by the angle 76 effectively confines electromagnetic radiation of the desired wavelength within the hollow-core region 32, particularly when the ratio of the outer diameter 70 of the second capillary 38 to the outer diameter 50 of the first capillary 36 is within the ranges highlighted above. The examples presented below, based on optical modeling, substantiate the high degree of confinement provided by the hollow-core optical fiber 10 of the present disclosure. Without being bound by theory, it is believed that the hollow-core optical fiber 10 effectively confines the electromagnetic radiation within the hollow-core region 32 via anti-resonant effect and negative curvature effect from the multiple first capillaries 36 facing the hollow-core region 32. The extraordinarily low confinement loss that the hollow-core optical fiber 10 exhibits while utilizing the plurality of cladding elements 14 with only the second capillary 38 nested within the first capillary 36 eliminates any need to incorporate a further capillary nested within the second capillary 38 and, thus, avoids the manufacturing difficulties that incorporating such further capillaries would cause.

Embodiments of the hollow-core optical fiber 10 may be made by the following method. The cladding elements 14 may be sleeved into the substrate 12 in a desired arrangement. The cladding elements 14 may be joined to the substrate 12 to form a preform assembly. The cladding elements 14 and the substrate 12 may be joined by any suitable, such as, but not limited to, fusing, welding, and adhesives. Techniques for welding include laser welding, flame welding, and plasma welding. The preform assembly may be redrawn into a fiber preform using conventional fiber redraw techniques. The fiber preform may then be drawn into the hollow-core optical fiber 10 using conventional fiber drawing techniques.

### EXAMPLES

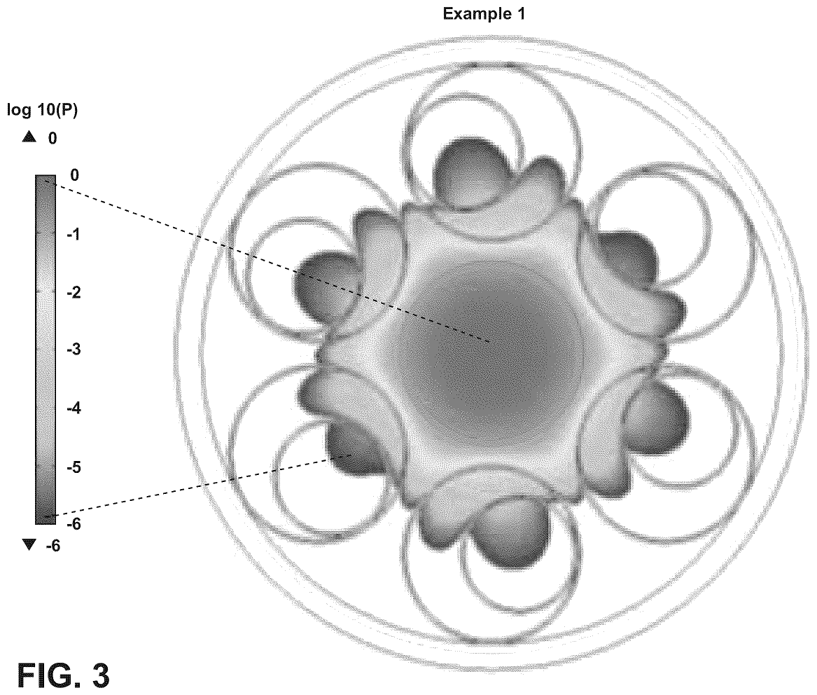

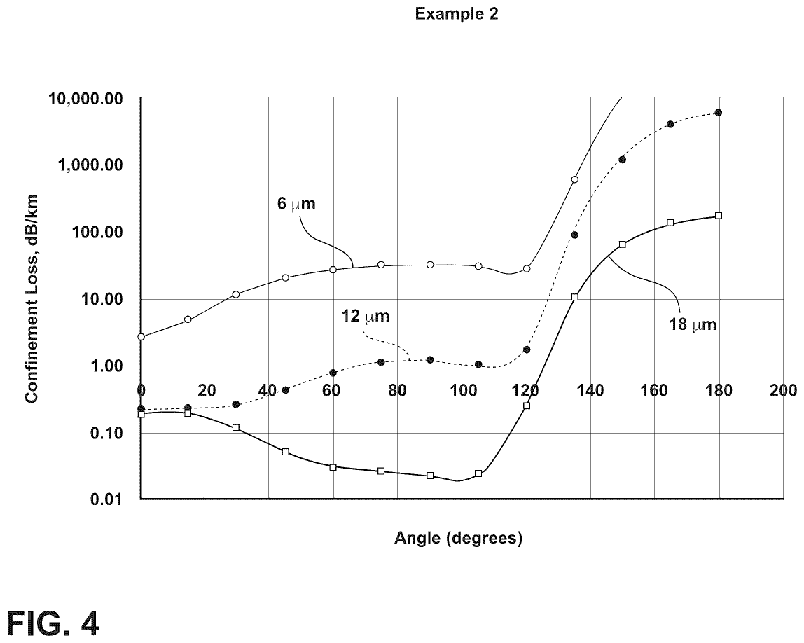

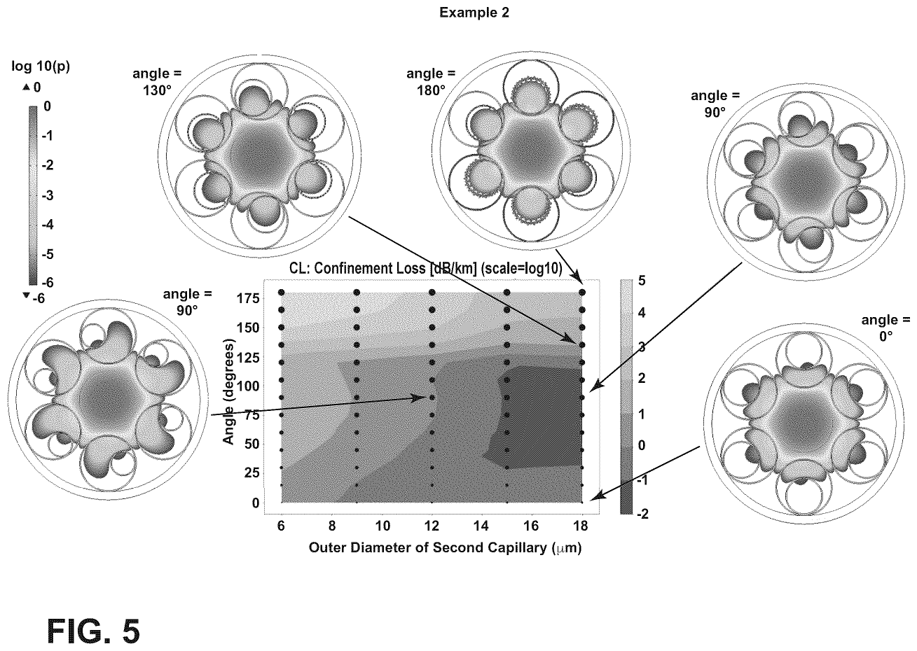

Example 1—For Example 1, in reference to FIG. 3, a computer model was utilized to determine confinement loss and to map the degree of confinement of the fundamental mode of electromagnetic radiation after assuming several variables. The modeled hollow-core optical fiber included six cladding elements. For each of the six cladding elements, the first line and the second line were assumed to be separated by an angle of 90 degrees. The hollow-core region was assumed to have an effective diameter of 34.5 μm. The cavity of the substrate surrounding the six cladding elements was assumed to be filled with air. Each of the first capillaries were assumed to have an outer diameter of 27.5 μm. Each of the second capillaries were assumed to have an outer diameter of 18 μm. All of the first capillaries were assumed to have a thickness of 0.50 μm. All of the second capillaries were assumed to have a thickness of 0.50 μm. Adjacent first capillaries were evenly spaced. The inner diameter of the inner surface of the substrate was assumed to be 89.5 μm. The computer model predicted a confinement loss of about 0.022 dB/km for electromagnetic radiation with a wavelength of 1550 nm. The computer model generated a contour plot (reproduced at FIG. 3) that shows normalized power of the electric field on a log scale (from −6 to 0). The contour plot shows good confinement of electromagnetic radiation within the hollow-core region with small losses through the cladding elements and the space between adjacent cladding elements. In addition, the contour plot shows that the electric field does not reach the substrate, which indicates low radiative losses.
Example 2—For Example 2, in reference to FIGS. 4 and 5, the computer model was again utilized to determine confinement loss for various hollow-core optical fibers with six evenly spaced cladding elements. In particular, confinement loss for electromagnetic radiation having a wavelength of 1550 nm was determined as a function of the outer diameter of the second capillary of each of the cladding elements and the angle separating the first line and the second line of each of the cladding elements. All the parameters are otherwise the same as Example 1.

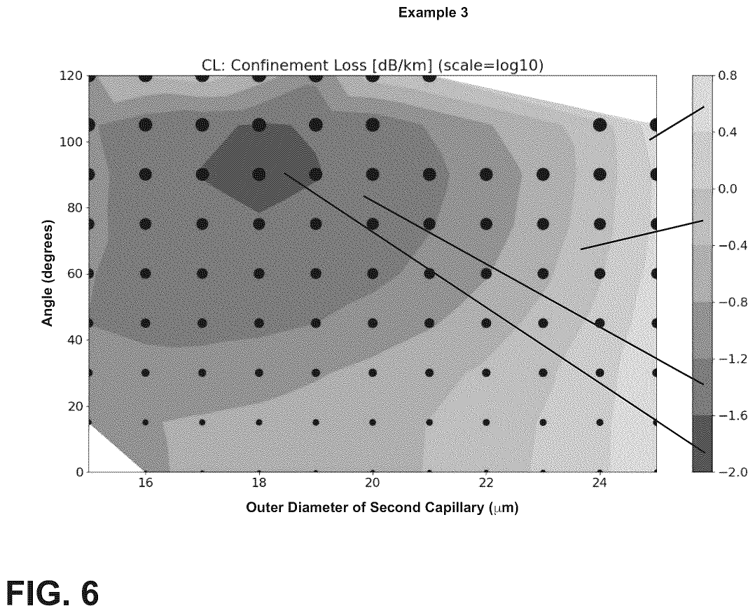

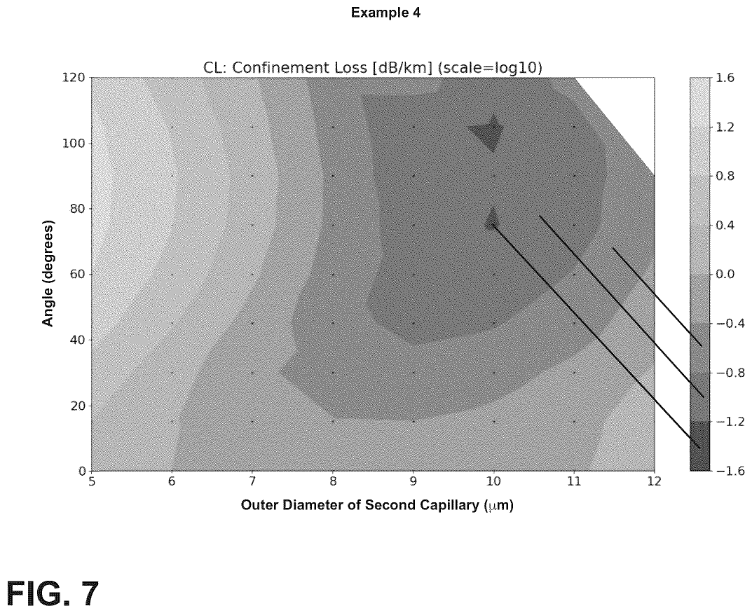

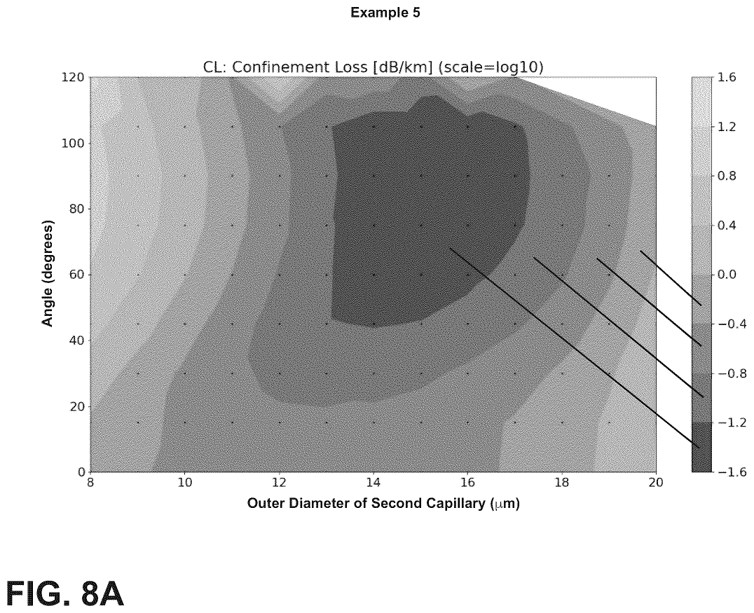

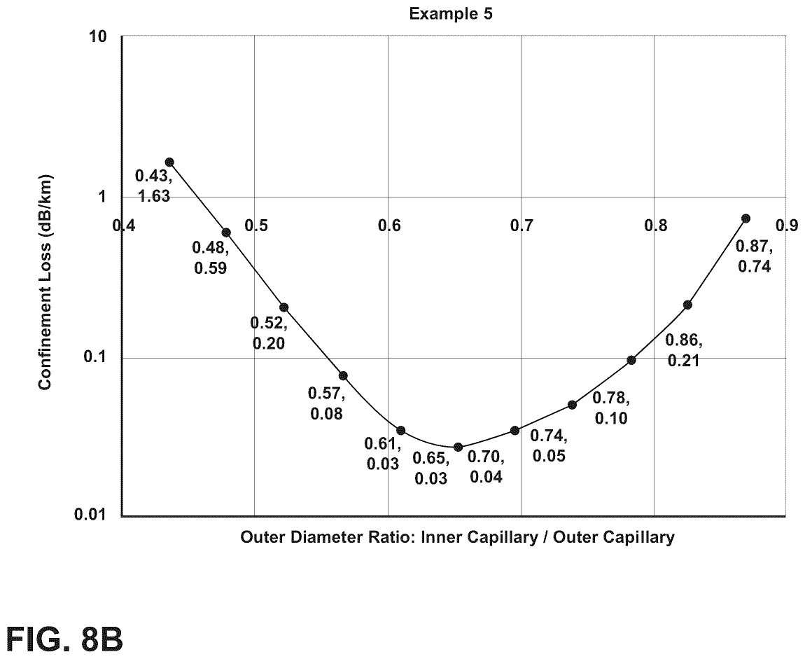

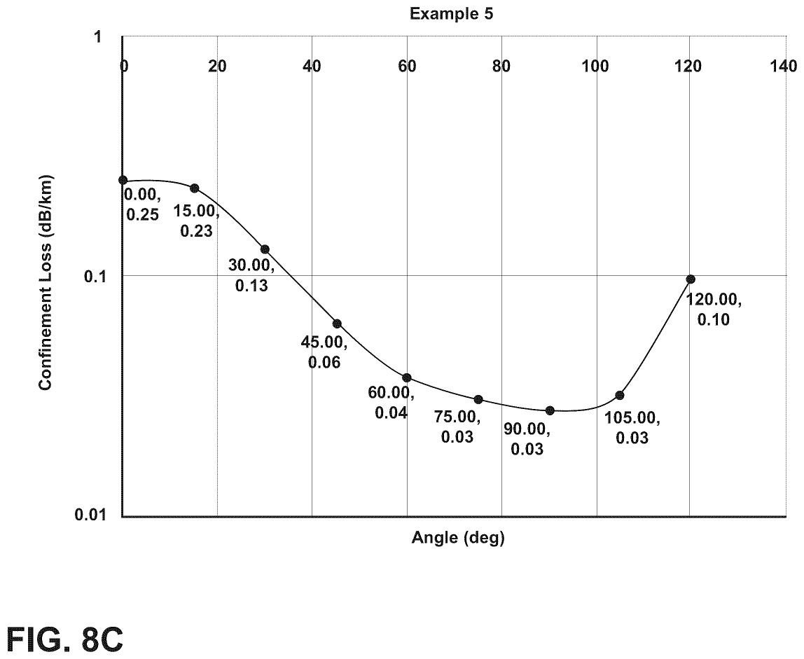

A graph plotting the calculated confinement loss as a function of the angle and the outer diameter of the second capillary is reproduced at FIG. 4. In addition, a three-axis graph (reproduced at FIG. 5) was generated to plot the calculated confinement loss as a function of the angle and the outer diameter of the of the second capillary. Associated contour plots for several of the modeled hollow-core fibers are also reproduced at FIG. 5. The graphs reveals that confinement loss can increase as a function of the angle increasing when the outer diameter of the second capillary of each of the cladding elements is too small (6 μm and 12 μm in this instance) but decreases substantially as a function of the angle increasing (at least up until about 110 degrees) when the outer diameter of the second capillary of each of the cladding elements is large enough (18 μm in this instance). Even for the larger outer diameter of 18 μm, confinement loss increases when the angle exceeds 110 degrees. Without being bound by theory, it is believed that confinement loss increases in such instances between the second capillaries are disposed too close to the hollow-core region to provide an anti-resonance effect.
Example 3—For Example 3, and in reference to FIG. 6, the computer model was again utilized to determine confinement loss for various hollow-core optical fibers with six evenly spaced cladding elements. In particular, confinement loss for electromagnetic radiation with a wavelength of 1550 nm was determined as a function of the outer diameter of the second capillary of each of the cladding elements and the angle separating the first line and the second line of each of the cladding elements. The model assumed that the hollow-core region had an effective diameter of 34.5 μm and that the outer diameter of the first capillary of each of the cladding elements was 27.5 μm. A three-axis graph was generated (and reproduced at FIG. 6) again plotting confinement loss as a function of the angle and the outer diameter of the second capillaries. The graph reveals that the modeled hollow-core optical fiber with an outer diameter of about 18 μm for the second capillaries and an angle of about 90 degrees generates the lowest confinement loss of less than 0.025 dB/km (e.g., less than −1.6 on a log₁₀ scale).
Example 4—For Example 4, and in reference to FIG. 7, the computer model assumed the hollow-core region had an effective diameter of 19 μm, the outer diameter of the first capillary of each of the cladding elements was 15 μm, the thicknesses of the first capillary and the second capillary of each of the cladding elements were 0.30 μm, the number of cladding elements was 6, and the wavelength of electromagnetic radiation transmitting through the modeled hollow-core optical fiber was 850 nm. Confinement loss was then calculated as a function of the outer diameter of the second capillary of each of the cladding element and the angle separating the first line and the second line of each of the cladding elements. The results are reproduced in the graph of FIG. 7. The results reveal that an outer diameter of about 10 μm for the second capillaries and an angle of about 105 degrees provided the lowest confinement loss of less than 0.058 dB/km. The ratio of the outer diameter of 10 μm of the second capillaries to the outer diameter of 15 μm of the first capillaries is 0.67.
Example 5—For Example 5, and in reference to FIGS. 8A and 8B, the computer model assumed the hollow-core region had an effective diameter of 29 μm, the outer diameter of the first capillary of each of the cladding elements was 23 μm, the thicknesses of the first capillary and the second capillary of each of the cladding elements were 0.43 μm, the number of cladding elements was 6, and the wavelength of electromagnetic radiation transmitting through the modeled hollow-core optical fiber was 1310 nm. Confinement loss was then calculated as a function of the outer diameter of the second capillary of each of the cladding element and the angle separating the first line and the second line of each of the cladding elements. The results are reproduced in the graph of FIG. 8A. The results reveal that an outer diameter of about 15 μm for the second capillaries and an angle of about 120 degrees provided the lowest confinement loss of less than 0.028 dB/km. The ratio of the outer diameter of 10 μm for the second capillaries to the outer diameter of 15 μm for the first capillaries is 0.65.

In addition, confinement loss was then plotted as a function of the ratio of the outer diameter of the second capillaries to the outer diameter of the first capillaries for the angle of 90 degrees. The results are reproduced at FIG. 8B. The results indicate that modeled hollow-core optical fibers with the ratio being a range of from 0.52 to 0.83 generated a confinement loss of less than 0.2 dB/km.

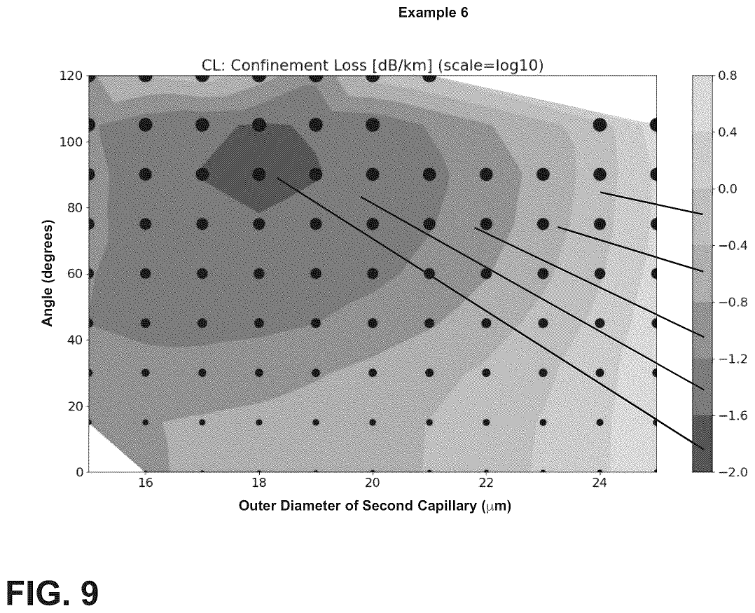

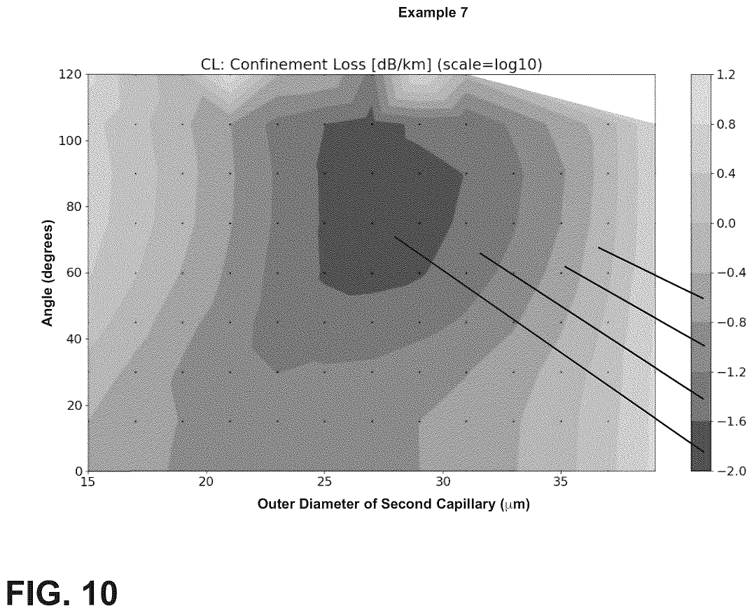

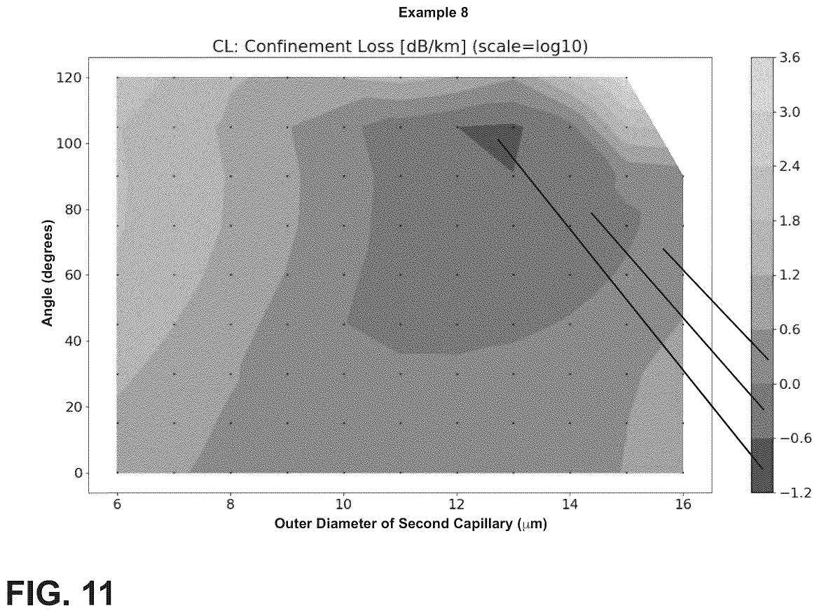

Further, confinement loss was then plotted as a function of angle assuming that the outer diameter of the second capillary was set at 15 μm. The results are reproduced at FIG. 8C. The results indicate that modeled hollow-core optical fibers where the angle was within a range of from about 40 degrees to 120 degrees generated a confinement loss of less than 0.1 dB/km.
Example 6—For Example 6, and in reference to FIG. 9, the computer model assumed the hollow-core region had an effective diameter of 34.5 μm, the outer diameter of the first capillary of each of the cladding elements was 27.5 μm, the thicknesses of the first capillary and the second capillary of each of the cladding elements were 0.50 μm, the number of cladding elements was 6, and the wavelength of electromagnetic radiation transmitting through the modeled hollow-core optical fiber was 1550 nm. Confinement loss was then calculated as a function of the outer diameter of the second capillary of each of the cladding element and the angle separating the first line and the second line of each of the cladding elements. The results are reproduced in the graph of FIG. 9. The results reveal that an outer diameter of about 18 μm for the second capillaries and an angle of about 90 degrees provided the lowest confinement loss of less than 0.022 dB/km. The ratio of the outer diameter of 18 μm for the second capillaries to the outer diameter of 27.5 μm for the first capillaries is 0.65.
Example 7—For Example 7, and in reference to FIG. 10, the computer model assumed the hollow-core region had an effective diameter of 53 μm, the outer diameter of the first capillary of each of the cladding elements was 42 μm, the thicknesses of the first capillary and the second capillary of each of the cladding elements were 0.79 μm, the number of cladding elements was 6, and the wavelength of electromagnetic radiation transmitting through the modeled hollow-core optical fiber was 2400 nm. Confinement loss was then calculated as a function of the outer diameter of the second capillary of each of the cladding element and the angle separating the first line and the second line of each of the cladding elements. The results are reproduced in the graph of FIG. 10. The results reveal that an outer diameter of about 27 μm for the second capillaries and an angle of about 90 degrees provided the lowest confinement loss of less than 0.016 dB/km. The ratio of the second diameter of 27 μm for the second capillaries to the outer diameter of 42 μm for the first capillaries is 0.64.
Example 8—For Example 8, and in reference to FIG. 11, the computer model assumed the hollow-core region had an effective diameter of 25 μm, the outer diameter of the first capillary of each of the cladding elements was 20 μm, the thicknesses of the first capillary and the second capillary of each of the cladding elements were 0.50 μm, the number of cladding elements was 6, and the wavelength of electromagnetic radiation transmitting through the modeled hollow-core optical fiber was 1550 nm. Confinement loss was then calculated as a function of the outer diameter of the second capillary of each of the cladding element and the angle separating the first line and the second line of each of the cladding elements. The results are reproduced in the graph of FIG. 11. The results reveal that an outer diameter of about 13 μm for the second capillaries and an angle of about 105 degrees provided the lowest confinement loss of less than 0.204 dB/km. The ratio of the outer diameter of 13 μm for the first capillaries to the outer diameter of 20 μm for the second capillaries is 0.65.

What is claimed is:

1. A hollow-core optical fiber comprising:
a substrate that is tubular comprising an inner surface surrounding a central longitudinal axis of the hollow-core optical fiber; and
a plurality of cladding elements spaced apart from each other and disposed within the substrate, the plurality of cladding elements together defining a hollow-core region surrounding the central longitudinal axis of the hollow-core optical fiber with the plurality of cladding elements disposed radially between the substrate and the hollow-core region, each of the plurality of cladding elements extending parallel to the central longitudinal axis, and each of the plurality of cladding elements comprising:
a first capillary that is tubular comprising (i) an outer surface having an outer diameter and contacting the inner surface of the substrate at a first contact region and (ii) an inner surface defining a first cavity with a first longitudinal axis parallel to the central longitudinal axis, and
a second capillary that is tubular disposed within the first cavity defined by the first capillary, the second capillary comprising (i) an outer surface having an outer diameter and contacting the inner surface of the first capillary at a second contact region and (ii) an inner surface defining a second cavity with a second longitudinal axis parallel to the central longitudinal axis,
wherein, for each of the plurality of cladding elements, a first line extends orthogonally from the central longitudinal axis through the first longitudinal axis and the first contact region,
wherein, for each of the plurality of cladding elements, a second line extends through the second longitudinal axis, the second contact region, and the first longitudinal axis,
wherein, for each of the plurality of cladding elements, the first line and the second line are separated by an angle that is within a range of from 20 degrees to 120 degrees,
wherein, for each of the plurality of cladding elements, a ratio of the outer diameter of the second capillary to the outer diameter of the first capillary is within a range of from 0.47 to 0.85, and
wherein, the plurality of cladding elements numbers within a range of from 5 to 8.

2. The hollow-core optical fiber of claim 1, wherein the inner surface of the substrate comprises an inner diameter that is within a range of from 30 μm to 140 μm.

3. The hollow-core optical fiber of claim 1, wherein for each of the plurality of cladding elements, the outer diameter of the first capillary is within a range of from 8 μm to 52 μm.

4. The hollow-core optical fiber of claim 1, wherein the first capillaries of adjacent cladding elements of the plurality of cladding elements are separated by a shortest distance that is within a range of from 1.8 μm to 6.0 μm.

5. The hollow-core optical fiber of claim 4, wherein for each of the plurality of cladding elements, the first capillary has a thickness, and a ratio of the shortest distance to the thickness of the first capillary is within a range of from 5 to 7.

6. The hollow-core optical fiber of claim 1, wherein for each of the plurality of cladding elements, the first capillary and the second capillary both have a thickness that is within a range of from 0.20 μm to 2.0 μm.

7. The hollow-core optical fiber of claim 1, wherein the hollow-core region has an effective diameter within a range of from 10 μm to 60 μm.

8. The hollow-core optical fiber of claim 1, wherein for each of the plurality of cladding elements, the outer diameter of the second capillary is within a range of from 13 μm to 24 μm.

9. The hollow-core optical fiber of claim 1, wherein for each of the plurality of cladding elements, a ratio of the outer diameter of the second capillary to the inner diameter of the inner surface of the substrate is within a range of from 0.14 to 0.25.

10. The hollow-core optical fiber of claim 1, wherein for each of the plurality of cladding elements, the ratio of the outer diameter of the second capillary to the outer diameter of the first capillary is within a range of from 0.60 to 0.72.

11. The hollow-core optical fiber of claim 1, wherein none of the plurality of cladding elements further includes another capillary disposed within the second cavity that the second capillary forms.

12. The hollow-core optical fiber of claim 1, wherein for each of the plurality of cladding elements, the angle separating the first line and the second line is within a range of from 60 degrees to 110 degrees.

13. The hollow-core optical fiber of claim 1, wherein
the outer diameters of the first capillaries of each of the plurality of cladding elements are approximately the same,
the outer diameters of the second capillaries of each of the plurality of cladding elements approximately the same, and
the angles separating the first line and the second line of each of the plurality of cladding elements are approximately the same.

14. The hollow-core optical fiber of claim 1, wherein
for each of the plurality of cladding elements, the angle separating the first line and the second line is within a range of from 80 degrees to 105 degrees, and
for each of the plurality of cladding elements, the outer diameter of the second capillary is within a range of from 17 μm to 19 μm.

15. The hollow-core optical fiber of claim 14, wherein the hollow-core optical fiber exhibits a confinement loss of less than 0.1 dB/km for electromagnetic radiation having a wavelength of 1550 nm.

16. The hollow-core optical fiber of claim 1, wherein
the hollow-core region has an effective diameter within a range of from 17 μm to 21 μm; and
for each of the plurality of cladding elements:
the outer diameter of the first capillary is within a range of from 13 μm to 17 μm;
the outer diameter of the second capillary is within a range of from 8.5 μm to 11.5 μm;
the first capillary and the second capillary both have a thickness within a range of from 0.25 μm to 0.35 μm; and
the angle separating the first line and the second line is within a range of from 40 degrees to 120 degrees.

17. The hollow-core optical fiber of claim 1, wherein
the hollow-core region has an effective diameter within a range of from 26 μm to 32 μm, and,
for each of the plurality of cladding elements:
the outer diameter of the first capillary is within a range of from 20 μm to 26 μm;
the outer diameter of the second capillary is within a range of from 12 μm to 18 μm;
the first capillary and the second capillary both have a thickness within a range of from 0.38 μm to 0.48 μm; and
the angle separating the first line and the second line is within a range of from 20 degrees to 120 degrees.

18. The hollow-core optical fiber of claim 1, wherein
the hollow-core region has an effective diameter within a range of from 31 μm to 37 μm; and,
for each of the plurality of cladding elements:
the outer diameter of the first capillary is within a range of from 23 μm to 31 μm;
the outer diameter of the second capillary is within a range of from 15 μm to 21 μm;
the first capillary and the second capillary both have a thickness within a range of from 0.4 μm to 0.6 μm; and
the angle separating the first line and the second line is within a range of from 40 degrees to 110 degrees.

19. The hollow-core optical fiber of claim 1, wherein
the hollow-core region has an effective diameter within a range of from 50 μm to 56 μm; and,
for each of the plurality of cladding elements:
the outer diameter of the first capillary is within a range of from 39 μm to 45 μm;
the outer diameter of the second capillary is within a range of from 23 μm to 32 μm;
the first capillary and the second capillary both have a thickness within a range of from 0.7 μm to 0.9 μm; and
the angle separating the first line and the second line is within a range of from 35 degrees to 110 degrees.

20. The hollow-core optical fiber of claim 1, wherein
the hollow-core region has an effective diameter within a range of from 22 μm to 28 μm and,
for each of the plurality of cladding elements:
the outer diameter of the first capillary is within a range of from 17 μm to 23 μm;
the outer diameter of the second capillary is within a range of from 10 μm to 15 μm;
the first capillary and the second capillary both have a thickness within a range of from 0.4 μm to 0.6 μm; and
the angle separating the first line and the second line is within a range of from 40 degrees to 110 degrees.
